(19) United States
(12) Patent Application Publication
(10) Pub. No.: US 2025/0383221 A1
(43) Pub. Date: Dec. 18, 2025

(54) Systems and Methods for Performing External Ultrasonic Flow Metering

(71) Applicant: Dune Labs Inc., Westlake Village, CA (US)

(72) Inventors: Bruce J. Buchan, Thousand Oaks, CA (US); Garo Sarkissian, Thousand Oaks, CA (US)

(73) Assignee: Dune Labs Inc., Westlake Village, CA (US)

(21) Appl. No.: 19/242,586

(22) Filed: Jun. 18, 2025

Related U.S. Application Data
(60) Provisional application No. 63/661,479, filed on Jun. 18, 2024.

(51) Int. Cl. G01F 1/66; G01F 1/667; G01F 15/18

(52) U.S. Cl. CPC G01F 1/662; G01F 1/667; G01F 15/18

(57) ABSTRACT

Systems and methods for performing external ultrasonic flow metering are illustrated. One embodiment includes an ultrasonic flow meter with a clamp-on carrier assembly, wherein the clamp-on carrier assembly includes a ratcheting clamp configured to externally mount the clamp-on carrier assembly to an assessed pipe. A medium has a direction of flow through the assessed pipe. The ultrasonic flow meter further includes at least three ultrasonic transducers, mounted to the clamp-on carrier assembly. Each of the at least three ultrasonic transducers is configured to transmit and/or sense ultrasonic acoustic waves propagating through the medium in the assessed pipe. The ultrasonic flow meter further includes a processor, mounted to the clamp-on carrier assembly and configured to calculate a flow rate for the medium based on time of flight measurements determined between two or more of the at least three ultrasonic transducers.

### CROSS-REFERENCE TO RELATED APPLICATIONS

The current application claims the benefit of and priority under 35 U.S.C. § 119(e) to U.S. Provisional Patent Application No. 63/661,479, entitled “Systems and Methods for Performing External Ultrasonic Flow Metering,” filed Jun. 18, 2024. The disclosure of U.S. Provisional Patent Application No. 63/661,479 is hereby incorporated by reference in its entirety for all purposes.

### FIELD OF THE INVENTION

The present invention generally relates to measuring flow rates of water. More particularly this specification is directed to systems and methods for performing external ultrasonic flow metering.

### BACKGROUND

In many regions of the world, as populations outgrow the readily available sources of water, water for human consumption is becoming a scarce resource. Yet, much of the water, post treatment for human consumption, is wasted away due to inefficient and/or sub-optimal patterns of human consumption.

This issue is frequently addressed by water meters, such as those personalized to specific system piping: in-line meters. In-line meters require that the water pipe be cut and the meter installed in-line with the water pipe such that the water flows through a piece of pipe that is attached to and is an integral part of the water meter. The advantage of an in-line water meter is that the manufacturer of the meter can adequately control all the critical dimensions required to accurately measure the volume of liquid flowing through a pipe. The cost and effort involved in deploying in-line water meters in existing master metered multi-family apartments, often require apartments to be re-plumbed to retrofit existing master metered properties with one sub-meter per apartment.

### SUMMARY OF THE INVENTION

Systems and methods for performing external ultrasonic flow metering are illustrated. One embodiment includes an ultrasonic flow meter with a clamp-on carrier assembly, wherein the clamp-on carrier assembly includes a ratcheting clamp configured to externally mount the clamp-on carrier assembly to an assessed pipe. A medium has a direction of flow through the assessed pipe. The ultrasonic flow meter further includes at least three ultrasonic transducers, mounted to the clamp-on carrier assembly. Each of the at least three ultrasonic transducers is configured to transmit and/or sense ultrasonic acoustic waves propagating through the medium in the assessed pipe. The ultrasonic flow meter further includes a processor, mounted to the clamp-on carrier assembly and configured to calculate a flow rate for the medium based on time of flight measurements determined between two or more of the at least three ultrasonic transducers.

In a further embodiment, the medium is water; and the at least three ultrasonic transducers include piezoelectric transceivers.

In another embodiment, a first ultrasonic transducer and a second ultrasonic transducer of the at least three ultrasonic transducers are configured to transmit and/or sense a first subset of the ultrasonic acoustic waves to propagate at oblique angles relative to the direction of flow of the medium.

In a further embodiment, a third ultrasonic transducer of the at least three ultrasonic transducers is configured to transmit and/or sense a second subset of the ultrasonic acoustic waves to propagate at approximate right angles relative to the direction of flow of the medium.

In a still further embodiment, at least some of the time of flight measurements determined by the third ultrasonic transducer are determined when the medium is present and not flowing through the assessed pipe.

In still yet a further embodiment, calculating the flow rate is based in part on a calculation of at least one diameter of the assessed pipe; and the calculation of the at least one diameter is derived from the at least some of the time of flight measurements determined by the third ultrasonic transducer.

In a further embodiment, calculating the flow rate is further based on a calculation of a cross-sectional area of the assessed pipe; and the calculation of the cross-sectional area is determined from the at least one diameter.

In another further embodiment, a fourth ultrasonic transducer of the at least three ultrasonic transducers is configured to transmit and/or sense a third subset of the ultrasonic acoustic waves to propagate at oblique angles relative to the direction of flow of the medium.

In a further embodiment, a first subset of the time of flight measurements are determined between the first ultrasonic transducer and the second ultrasonic transducer; and a second subset of the time of flight measurements are determined between the first ultrasonic transducer and the fourth ultrasonic transducer.

In a still further embodiment, a more reliable subset of the first subset and the second subset of the time of flight measurements is determined by the processor; and the more reliable subset is used to determine the flow rate.

In another embodiment, the ratcheting clamp includes: a mounting base assembly; and a pipe clamping mechanism including a right clamp and a left clamp.

In a further embodiment, the pipe clamping mechanism is attached to the mounting base assembly using a male slide mount and a female slide mount.

In another further embodiment, the pipe clamping mechanism is released when a keyed tool is placed into one side of the mounting base assembly.

In another further embodiment, the ratcheting clamp is reconfigured, using the pipe clamping mechanism, to attach to a second pipe; and the second pipe has a different diameter than the assessed pipe.

In a further embodiment, the assessed pipe and the second pipe each have external diameters within a range of ½″ to 2″.

In another further embodiment, the pipe clamping mechanism is held in place, when the ratcheting clamp is closed, using a clamp locking clip and a clamp locking catch.

In another embodiment, the clamp-on carrier assembly further includes at least one additional ratcheting clamp; and each of the at least one additional ratcheting clamp is mounted to a singular a unidirectional bearing.

In another embodiment, the processor is further configured to detect a presence or absence of ultrasonic acoustic waves travelling along an exterior surface of the assessed pipe.

In a further embodiment, the processor is further configured to determine an instance of tampering from detecting the absence of ultrasonic acoustic waves travelling along the exterior surface of the assessed pipe.

In a further embodiment, the ultrasonic flow meter further includes a network interface; and the processor is further configured to transmit an alert to an external device, in response to the instance of tampering, using the network interface.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an ultrasonic flow meter implemented in accordance with some embodiments of the invention.

FIGS. 2A-2B conceptually illustrate externally-mounted transducers, forming part of an ultrasonic flow meter implemented in accordance with several embodiments of the invention.

FIGS. 3A-3B conceptually illustrate a ratcheting pipe clamp mechanism capable of attaching an ultrasonic flow meter to a pipe in accordance with numerous embodiments of the invention.

FIGS. 4A-4F depict photographs of a ratcheting pipe clamp mechanism used in attaching an ultrasonic flow meter to a pipe of various sizes in accordance with certain embodiments of the invention.

FIGS. 5A-5C illustrate a three-piezoelectric transceiver assembly for use in by ultrasonic flow meter implemented in accordance with some embodiments of the invention.

FIGS. 6-7 illustrate a connected metering system that determines water consumption in accordance with specific embodiments of the invention.

### DETAILED DESCRIPTION

Turning now to the drawings, systems and methods in accordance with many embodiments of the invention may be configured to enable external, non-intrusive, ultrasonic flow meters to consistently measure flow rates. In doing so, these meters may be used to allow ultrasonic flow rate measurements that can be utilized with a wide variety of water pipe materials (e.g., copper, PEX, PVC, galvanized steel), diameters, and/or wall thicknesses. These flow rates may be applied to purposes including but not limited to residential and commercial water metering and sub-metering.

Ultrasonic flow meters configured in accordance with various embodiments of the invention may include, but are not limited to a plurality on ultrasonic transducers mounted to clamps. In some cases, carrier assemblies may operate as intermediaries, where the carrier assembly is itself configured to be externally mounted on pipes via the clamps. In accordance with many embodiments of the invention, sets (2, 3, 4, etc.) of ultrasonic transducers may be, additionally and/or alternatively, mounted to the carrier assemblies and/or meters. The configurations may be arranged to be externally mounted (e.g., clamped) on the pipe such that the ultrasonic transducers are in a fixed position with respect to the external surface of the pipe, allowing them to send and receive ultrasonic waves to and from the external surface. In doing so, these configurations may be suitable for a range of pipe sizes, wall gauges, and different materials.

### I. Background

There have been efforts and innovations in the water and consumer electronics industries to tackle some of the financial and effort-based challenges associated with monitoring water usage. Yet none of the existing solutions have been widely adopted by consumers due to inherent fundamental technical and practical limitations that severely curtail their applicable use cases. Limitations of known solutions can include one or more of the following:
(1) inability to capture data on outdoor water usage for landscaping and pools;
(2) inability to detect outdoor water leaks such as broken sprinkler heads;
(3) reliance on intrusive and expensive professional “in-line” installations;
(4) reliance for access to the home/site's local wireless network which often is not robust enough to maintain persistent and continual connectivity for the life of the product that could be upwards of 10 years;
(5) reliance on close proximity to an electrical outlet to power the product;
(6) need to install multiple products at each water consumption and/or potential leak point/faucet across a home/site;
(7) need to install multiple water meters for an apartment if the water lines are shared, such as coming from a shared water heater; and
(8) need to replumb in order to do sub-metering if the water pipes serving an apartment are not dedicated and continue onto other apartments, such that a meter's reading may be indicative of water use in multiple apartment units.

Meanwhile, water meters typically have to comply with national and/or state level requirements such as those in:
(1) “NIST Handbook 44 2019” from the National Institute of Standards and Technology, which is adopted by the National Conference on Weights and Measures (NCWM);
(2) “NCWM Publication 14. Liquid Measuring Devices 2019”, and their National Type Evaluation Program (NTEP); and
(3) the California Department of Food and Agriculture's (CDFA) “Weights and Measures Field Reference Manual (2019)”, which contains extracts from the California Code of Regulations Title 4 Division 9.

All of the foregoing are incorporated herein by reference. Existing governmental requirements include, but are not limited to: measurement accuracy of water consumption levels; repeatability of measurements; ability to audit the measurement results; and requirements around tamper proofing of meters. Residential water meters that comply with governmental requirements are commercially available. Some meters are also certified for water sub-metering applications, as can be seen in the CDFA's California Type Evaluation Program's approval database. Regardless of the underlying technology utilized, most and/or all of known water meters that comply with the regulatory requirements are of the in-line variety.

An especially non-invasive approach to water monitoring is found in ultrasonic water meters (also referred to as “ultrasonic flow meters” in this disclosure), which work on the principle of measuring time-of-flight of ultrasonic waves through the (e.g., water) medium in a pipe and detecting changes to the time-of-flight and/or to the phase of the ultrasonic waves as the water flow rate in the pipe changes. The theory and principles of operation of ultrasonic water flow metering are known. For example, see: “Ultrasonic Sensing Technology for Flow Metering” by Srinvas Lingam, Using Ultrasonic Technology for Flow Measurement, September 2017, the disclosure of which, including the disclosure related to systems and methods for measuring flow, is incorporated by reference herein in its entirety. Ultrasonic flow meters such as (but not limited to) the ultrasonic flow meters described in U.S. Pat. No. 11,624,639, titled “Ultrasonic Flow Metering,” filed Apr. 9, 2020, and issued Apr. 11, 2023, the disclosure for which is incorporated by reference in its entirety, may further described this framework.

Nevertheless, an enduring problem associated with ultrasonic water meters is that water pipes can be constructed from different types of materials having variation in outer diameter and wall thickness. Many existing solutions require installers to attempt to attach ultrasonic flow meters by selecting a clamp (that is appropriate to a specific pipe diameter) from a set of clamps (that are each designed for different pipe diameters). When the incorrect clamp is selected, errors can be introduced into flow measurements due to a lack of direct contact between the transceivers within the ultrasonic flow meter and the exterior surface of the pipe. In extreme cases, for pipes constructed from plastics (e.g., PEX and/or PVC) selections of too-small clamps, this can result in pipes cracking.

Therefore, ultrasonic flow meter configurations implemented in accordance with many embodiments of the invention may be configured to deal with water pipes of varying external diameters (optimized, but not exclusive to the range of ½″-2″ diameter pipes) and made of different materials (e.g., copper, PEX, PVC, galvanized steel). This design is mechanically suitable to a range of pipe sizes and materials. In particular, meters configured in accordance with numerous embodiments may be attached clamps that have angled fingers which slide towards each other to grab the pipe and secure the meter.

Systems and methods in accordance with numerous embodiments of the invention may be used to facilitate self-service business models. Such approaches may, especially, be effective for smaller properties including but not limited to Accessory Dwelling Units (ADUs), duplexes, triplexes, and quadplexes. In accordance with some embodiments, universal clamping and meter calibration processes may enable simple self-installation of the (ultrasonic) water meters by individuals (e.g., non-professional property owners, plumbers, or handymen). Through identification/tracking functionality including but not limited to QR codes, the property owners can associate individual meters with corresponding dwelling units. Additionally or alternatively, property owners may have the capacity to configure automated reporting criteria on a varying basis (e.g., daily, weekly, monthly, yearly, in response to request). By doing this, property owners may receive (e.g., transmitted) meter reads at predetermined times (e.g., monthly) that allow for accurate billing on water use. In numerous cases, these meter configurations may enable simple self-service metering business models for various types of residential water pipes using a singular product.

### II. Ultrasonic Flow Meter Configurations

Ultrasonic flow meter(s) can be used with products and with computer programs to provide simple and cost effective solutions for monitoring, managing and optimizing water consumption for an entire home (indoors and outdoors), as well as a multi-tenant and/or commercial building/facility (entire sites and subunits such as each apartment, office, room, etc.).

Ultrasonic flow meters in accordance with various embodiments of the invention may include three (or more) transducers (including but not limited to transceivers) that are arranged along the pipe and oriented at different angles to perpendicular, which can be referred to as transceivers A, B, and C. Depending on the diameter of the pipe, the pipe material, and the wall thickness, the ultrasonic flow meter can utilize time-of-flight measurements between transceivers A and B to measure pipe diameter and wall thickness, and/or the longer time-of-flight measurements between transceivers A and C. In accordance with many embodiments of the invention, fluctuating factors including but not limited to temperature may affect these measurements. Specifically, measurements including but not limited to the density of materials and/or the signal speed in the material can change with temperature. Therefore, in some scenarios, the temperature can cause the travel path to change enough that a pairing of alternative transceivers (for example A and C instead of A and B) works better for measurements determined in certain temperature ranges.

The difference in upstream and downstream time-of-flight measurements between a pair of transceivers (e.g., A and B and/or A and C) is proportional to the rate of liquid flow. The signal travel between transceiver pairs is typically at an angle such that the transmitted ultrasonic signal goes through the wall of the pipe, into the liquid, bounces off the opposite wall of the pipe, and then to the paired transceiver (a V-bounce). In some cases a W-bounce is measured. The time taken from transmission at a first transceiver to reception at a second transceiver (or at the same transceiver in some instances) is often referred to as a time-of-flight measurement. A single pair of transceivers at fixed angles and spacing has a limited combination of pipe diameters, pipe materials, and wall thickness that they can work with. In many embodiments, at least two alternative transceiver pair spacings are provided, and carefully selected to provide different angles for B and C (and potentially additional transceivers) that allow a wider range of pipe diameter and pipe material compatibility for the two pairings.

In order to make an ultrasonic flow meter compatible with pipes having different diameters, ultrasonic flow meters in accordance with many embodiments of the invention utilize a ratcheting pipe clamp mechanism having a pair of clamp arms with angled fingers that are configured to slide towards each other and clasp a pipe. Mechanical pressure on the pipe is increased by moving the clamp arms closer together. Teeth similar to those employed in a cable tie (for, non-limiting, example 3-clamp locking catches and/or 4-clamp locking clips) may be used to keep the clamp arms from loosening. When installed on a pipe, the clamp mechanism on many embodiments of the invention has holes through which a wire seal and/or a lock can be applied to help prevent and/or identify tampering.

While the various ratcheting pipe clamp mechanisms described herein are discussed in combination with specific ultrasonic flow meter transducer configurations, ratcheting pipe clamp mechanisms can be utilized in combination with any of a variety of different types of ultrasonic flow meters and/or transducer configurations including (but not limited to) the ultrasonic flow meter transducer configurations disclosed in U.S. Pat. No. 11,624,639, titled “Ultrasonic Flow Metering,” the disclosure for which is incorporated by reference in its entirety above.

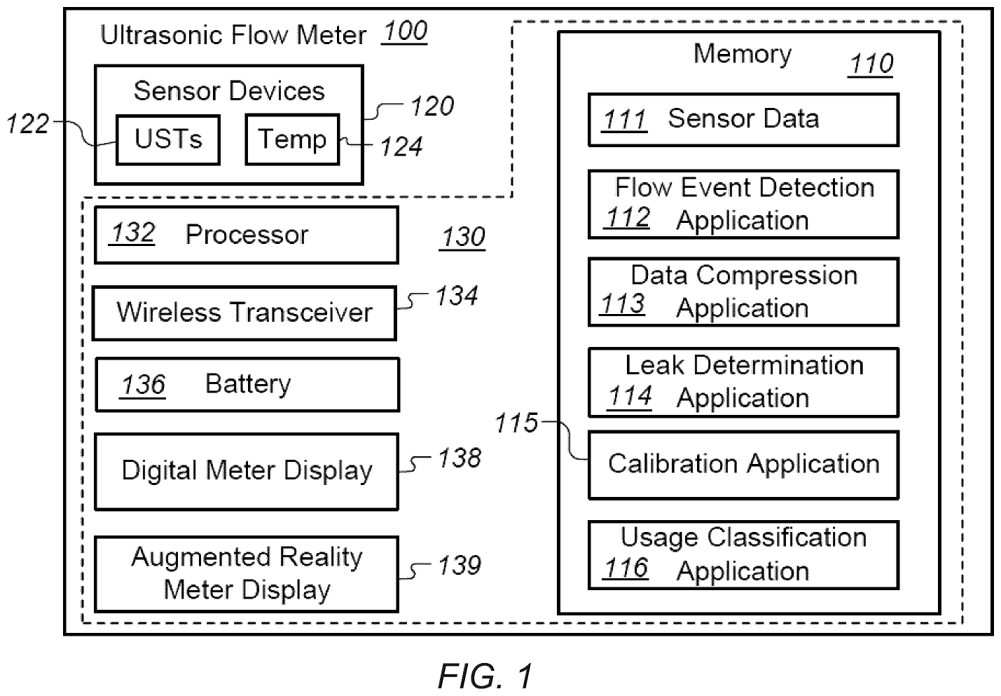

A conceptual block diagram illustrating details of an ultrasonic flow meter for measuring water flow, in accordance with some embodiments of the invention, is illustrated in FIG. 1. Ultrasonic flow meters 100 can be installed at the target home, apartment and/or site. In various embodiments, these meters 100 may be configured to be: (i) easily installed by an able bodied person with no plumbing expertise; (ii) self-sufficient with no requirement for external electrical power sources and/or local network connection for data transport; and (iii) able to accurately measure/sense data sufficient to calculate water flow and consumption levels through the water pipes they are installed on. The ultrasonic flow meters 100 can include but are not limited to: sensor devices 120; processor(s); wireless transceivers; (e.g., digital meter, QR code-based, augmented reality meter) displays; and memory 110. Memory 110 can store sensor data as well as various applications including but not limited to: flow event detection application(s); data compression application(s); leak determination application(s); calibration application(s); and usage classification application(s). In multiple embodiments, subsets of the components, shown in the example of FIG. 1, may be included in flow meters 100. In some embodiments, sensor devices 120 might include the ultrasonic transducers 122 and omit the temperature sensors 124. The electronic circuit assemblies 130 might include processors 132, wireless transceivers 134, and memory 110 but omit batteries 136, digital meter displays 138 and augmented reality meter displays 139. The memory 110 might include sensor data 111 and calibration applications 115 but omit flow event detection applications 112, data compression applications 113, leak determination applications 114 and usage classification applications 116. In a number of embodiments, the flow meters 100 might additionally include the temperature sensor(s) s 124, the assemblies 130 might additionally include batteries 136, and the memory 110 might additionally include flow event detection applications 112 and leak determination applications 114.

In various embodiments, ultrasonic flow meters 100 can be configured to attach externally onto the water pipe at various locations such as in the vicinity of the water meter on the home/site side, and/or other locations upstream from pipes being divided for outdoor vs. indoor use in cases where outdoor water usage is to be monitored; and/or on pipes entering each apartment. The ultrasonic flow meters 100 may be configured to be compact in size to require a relatively small amount of exposed water pipe length for installation. Ultrasonic flow meters 100 can also be configured to be installed on water pipes that have been subdivided into the pipes for use by each apartment and/or office, including inside drywalls and/or in outdoor areas exposed to weather and/or subterranean enclosures, and in some cases separate meters 100 can be installed such as where several pipes (e.g., separate hot and cold water pipes) enter each apartment and/or other configurations.

In multiple embodiments, the ultrasonic flow meters 100 may include but are not limited to two or more ultrasonic transducers 122, each tightly coupled externally to the water pipe and of a quality and type suitable for water metering applications. In several embodiments, each ultrasonic transducer may have a disc shape with a diameter between 5 mm and 20 mm. Each ultrasonic transducer can be configured to generate and receive a sequence of precisely timed and choreographed directional ultrasonic pulses through the water inside the water pipe and utilize a delta time-of-flight methodology and/or other suitable technique for ultrasonic water flow measurement. In many cases, these pulses may be transmitted at oblique angles relative to the direction of flow.

In multiple embodiments, ultrasonic flow meters 100 may be configured to capture data sufficient for corresponding systems to automatically self-determine pipe diameters. In particular, ultrasonic flow meters 100 can self-determine an accurate value for the inner diameter of the pipes they are installed on.

In various embodiments, this may be achieved by taking measurements of the time-of-flight of ultrasonic pulses from a third transducer that are reflected back to itself. This third transducer can be tightly coupled externally and oriented orthogonally to the pipe. The different reflections measured by the third, orthogonally-oriented transducer include: (1) to and from the pipe wall/water near side interface; and (2) to and from the water/pipe wall far side interface. In some embodiments, the integrity of the detected/reflected signal from the orthogonally-oriented (i.e., third) transducer may be amplified or focused (e.g., relative to the others). For example, in some embodiments of the invention, signals transmitted from that transducer may be conditioned so that detection of multipath signals is minimized. In essence, this could be used to enhance the ultrasonic beam. In particular, such an enhanced detection scheme may be based on various approaches, including but not limited to beamforming. In accordance with various embodiments, in the simplest form, an impulse signal may be transmitted and response detected based on the specific multipath and pipe configuration, while new transmit signals may be generated that are essentially the inverse of the first received signals (resulting in a received signal that is closer to an impulse signal, where the energy is concentrated/focused). Systems applying the above approach may address a major challenge with the vertical piezo signal detection: that there are multiple reflections from each of the media interfaces. Therefore, by beamforming (or otherwise signal conditioning/filtering) the transmit signals, systems in accordance with various embodiments of the invention are able to enhance focus the energy into the desired signal that's received.

The difference between the two time-of-flight measurements is often proportional to the inner pipe diameter. In miscellaneous embodiments, the derivation of the inner diameter of the pipe can be improved by taking the measurements when specific conditions of no water flow over a specified minimum amount of time occurs. In numerous embodiments, ultrasonic transducers are externally coupled to a water pipe and generate, transmit and receive directional ultrasonic pulses through the water inside the pipe at a frequency of between 0.25 MHz to 10 MHz. In certain embodiments, the frequency range can be optimized within the range of 0.5 MHz to 5 MHz and, specifically, between about 1 MHz to about 2 MHz. In some embodiments, the medium being measured is not water but another liquid and/or gas flowing through the pipe, while acoustic frequency range should be consistent with the medium being measured. For example, a frequency range of 160 KHz to 600 KHz may be used when flow meters 100 may be configured to measure certain types of gas(es).

In some embodiments, the flow meters 100 may include one or more temperature sensors 124 configured to measure and to capture the water pipe temperature and/or the ambient temperature in the immediate vicinity of the water pipe(s). The data can be provided, on an ongoing and/or periodic basis, and/or with each water flow event, to temperature compensation circuitry, for example in electronic circuit assemblies 130. The data can be used for temperature compensation calibration adjustment, and/or to determine if the flow meters 100 may be connected to a cold water pipe and/or a hot water pipe.

In certain embodiments, ultrasonic flow meters 100 can include electronic circuit assemblies 130 having components such as: drivers; data logger(s), processor(s), power management circuitry, I/O's and other circuits, as well as firmware code and algorithms. The electronic circuit assemblies 130 can be configured: to (i) drive the sensors and/or transducers; (ii) collect data from the sensors; (iii) process data from the sensors to calculate water flow rates; (iv) store data; (v) make decisions to identify water usage patterns that can cause alerts to be sent; and/or (vi) manage the transport of the data and/or calculation results as well as potential notifications via the wireless transceiver. In many embodiments, the electronic circuitry may include batteries with enclosures suitable for outdoor use and an antenna assembly/network. In certain embodiments, the electronic circuit assemblies 130 can be coupled to a local area wireless network, particularly ones that utilize low power such as Bluetooth Low Energy (BLE). In a number of embodiments, the electronic circuit assemblies 130 may include but are not limited to one or more Low Noise Amplifier (LNA) stages and filters to improve the performance when collecting data from the sensors, and thereby reducing the signal transmission power used for a successful link. The LNA is designed to pass and amplify desired signals in the selected frequency range of 1-2 MHz, and filter out signals outside the selected frequency range.

In several embodiments, the wireless transceivers may be configured to transport the data and other information from the electronic circuit assemblies 130 to computer servers. In some embodiments, the wireless transceiver can utilize wide area networks (WAN) such as cellular LTE Cat M1 and/or NB-IoT network(s), and/or other Low Power WAN (LPWAN) such as Sigfox and/or LoRa, and may have a fallback to a 2G cellular network. In multiple embodiments, the type of wireless transport network may be selected to enable multi-year battery operation of the ultrasonic flow meters 100, without the requirement of recharging.

In many embodiments, ultrasonic flow meters 100 may be configured to operate reliably for multiple years, including (but not limited to) at typical outdoor temperature ranges and/or inside walls. In some embodiments, ultrasonic flow meters 100 may be configured to operate reliably without change and/or charging of batteries 136 for at least 7 years. In numerous embodiments, the operation may be independent from on-premises resources such as electrical power and network access.

In certain embodiments, ultrasonic flow meters 100 may be configured for installation in relatively tight quarters with limited physical access to the water pipe. In some cases, ultrasonic flow meters 100 may be configured for installation within walls. Such capabilities greatly increase the flexibility of installation, allowing for a broad range of use cases. In a number of embodiments, ultrasonic flow meters 100 may be separated into two parts. The first part is a set of ultrasonic transducers 122 embedded in a small connector assembly of sensor devices 120 suitable for use with a range of pipe sizes. The connector assemblies can be configured to clip onto and/or otherwise attach onto water pipes having a range of diameters (e.g., 0.5″ to 1.5″). The transducers 122 in the connector assemblies are adjacent to each other on the same side of the water pipe and separated by a small, fixed distance (e.g., in range of 0.5″ to 2″ separation). In multiple embodiments, the transducers 122 are positioned on opposite sides of the water pipe, pointing at each other with an angle of less than 90 degrees and offset by a distance that might even be under 1″. In some embodiments, connector assemblies can also include one or more temperature sensors 124. The second part of flow meters 100 may be electronic circuit assemblies 130. Electronic circuit assemblies 130 could include a battery pack and internal and/or external antenna network. In various embodiments, the battery pack may include a Lithium Thionyl battery and a super-capacitor, to better handle high pulse current draw and improve battery life. In many embodiments, the battery pack may be designed to be in a stand-alone enclosure that is physically coupled to electronic circuit assemblies 130 to allow for replacement/swapping of the battery pack at a future time post initial installation. In some embodiments, the super-capacitors may be an integrated part of electronic circuit assemblies 130, so that a battery pack contains only a battery and its replacement does not replace the super-capacitor. There may also be different capacity battery packs to choose from, depending on the expected initial and/or incremental longevity of the ultrasonic flow meters 100.

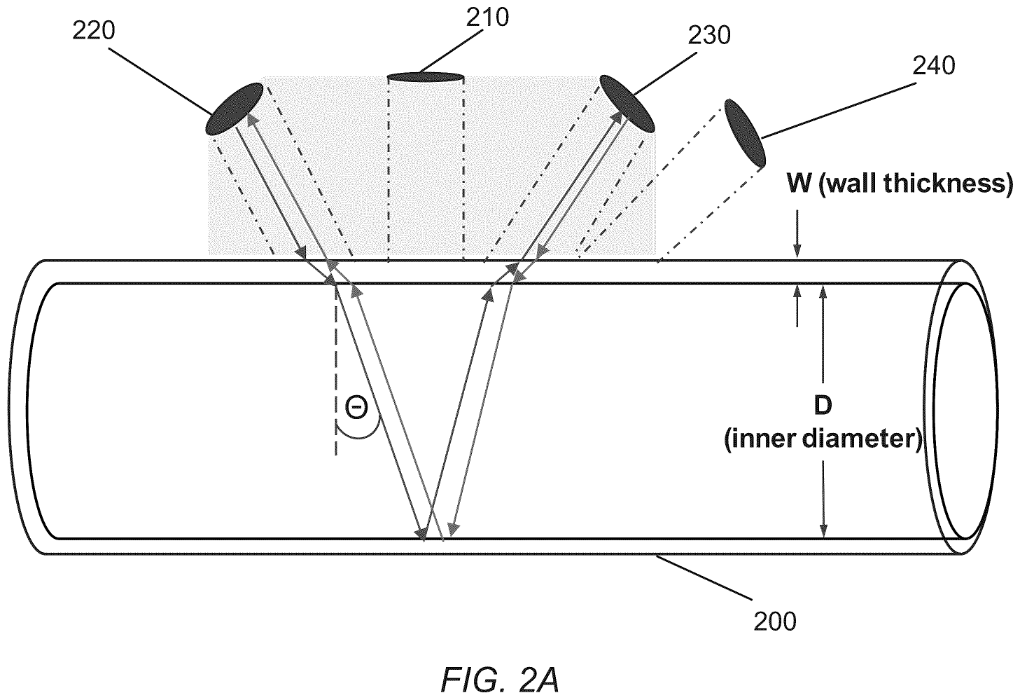

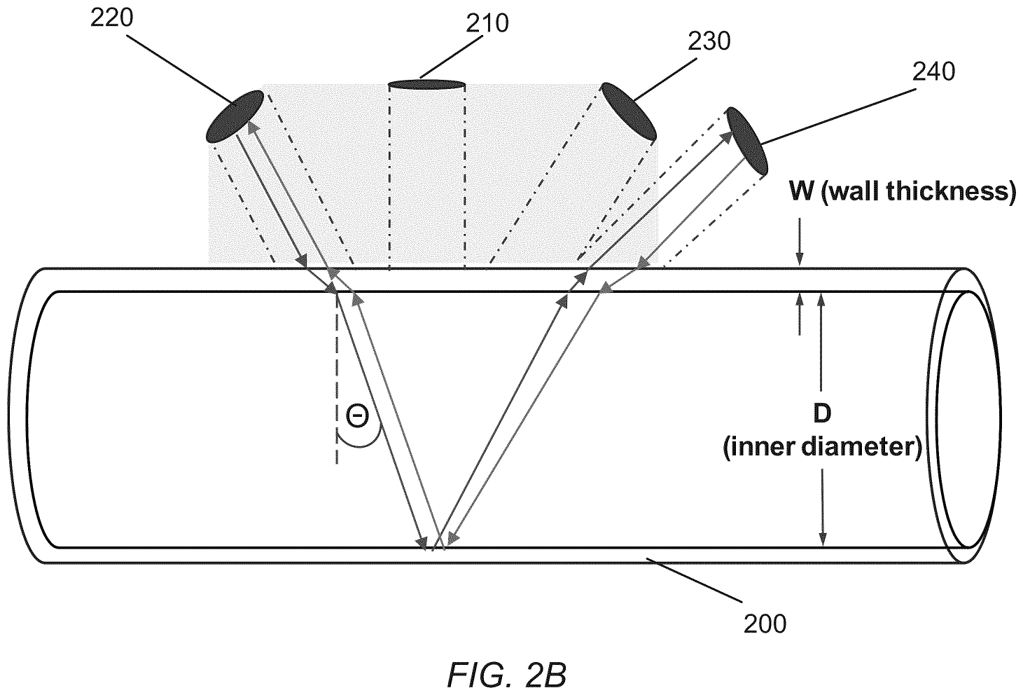

Diagrams depicting externally-mounted transducers, forming part of an ultrasonic flow meter implemented in accordance with several embodiments of the invention, are illustrated in FIGS. 2A and 2B. In accordance with many embodiments of the invention, groups (commonly three or four but, in many cases, more) of transducers may be utilized by ultrasonic water meters in accordance with various embodiments of the invention. An assembly of four ultrasonic transducers 210, 220, 230, 240 is depicted in the illustrated embodiment, all of which are mounted to contact the outside of a water pipe 200.

As described above, the ultrasonic flow meter includes multiple transducers 210, 230, 240 that are oriented at an angle relative to the exterior surface of the pipe. Transducers 210 and 230 form a pair that can be used to perform time-of-flight measurements in both directions. Transducers 210 and 240 also form a second pair that can be used to perform time-of-flight measurements in both directions. Further, as referenced above, at least one of the transducers 220 can be oriented orthogonally to the pipe to determine reflections including but not limited to and from the pipe wall/water near and far side interfaces, as the difference between the two time-of-flight measurements is often proportional to the inner pipe diameter.

A processing system (not shown), which can include a microprocessor, memory and appropriate machine-readable instructions stored within the memory for configuring the processor, can be utilized to initiate the capture of measurements using one and/or both of the pairs of transducers. The processing system can then utilize the captured measurements to determine at least one of the pipe diameter, pipe wall thickness, and/or pipe material. Systems configured in accordance with many embodiments of the invention may use this information to derive values including but not limited to the inner and outer diameters of the pipe. In accordance with some embodiments, one of these values may be used in determining the others. For example, wall thickness can vary depending on the material, the grade, and/or and the diameter of the pipe. In accordance with many embodiments of the invention, when some values can be determined but others remain unknown, a lookup can be done against a known table of specifications to determine the unknown specifications.

In several embodiments, the processing system captures a first set of time-of-flight measurements using a first pair of transducers (e.g., 210 and 230) and determines whether the measurements are reliable to use to determine at least one of the pipe diameter, and pipe wall thickness. In the event the measurement is unreliable, the processing system captures a second set of time-of-flight measurements using a second pair of transducers (e.g., 210 and 240). In certain embodiments, the processing system captures at least two sets of time-of-flight measurements using at least two different pairs of transducers (e.g., 210 and 230; and 210 and 240) and determines at least one of the pipe diameter, and pipe wall thickness using the most reliable set of measurements.

As can be readily appreciated, the specific number and sequence utilized by the processing system to capture time-of-flight measurements and the manner in which the processing system utilizes the time-of-flight measurements to calculate at least one of pipe diameter and pipe wall thickness is largely dependent upon the requirements of specific applications.

While the ultrasonic flow meters described above with reference to FIGS. 2A and 2B include four transducers that can be configured to enable the capture of at least two sets of time-of-flight measurements using at least two different pairs of transducers, ultrasonic flow meters can include more than four transducers or more than two pairs of transducers that are capable of being used to capture time-of-flight measurements. For example, ultrasonic flow meters in accordance with a number of embodiments of the invention include multiple pairs of transducers, where no transducer is common to any two pair of transducers. As can readily be appreciated the specific number and configuration of transducers utilized within an ultrasonic flow meter to form multiple pairs of transducers for the purpose of capturing time-of-flight measurements for determining of at least one of pipe diameter and/or pipe wall thickness is largely dependent upon the requirements of specific applications.

Ultrasound wave paths (i.e., the arrows of the figure), shown to/from transducers 220 and 230, respectively, may be used to determine water flow rates in accordance with various embodiments of the invention. The paths are shown travelling though the assembly body, through pipe walls, and/or through water within. Note that although the paths are shown separated for clarity in practice, they could be co-incident with each other, albeit in opposite directions.

To calculate the water flow rate the basic equation is:

$$Q = A \cdot V$$

where Q is the water flow rate, typically in gallons per minute, or liters per minute; A is the cross-sectional area of the inner pipe 200 through which water flows; and V is the velocity of the flowing water. To get highly accurate measurements, for example within the 1.5% of accuracy over expected operating conditions which is typically required by meter certification bodies, one needs to have an accurate enough value of the pipe's 200 inner diameter D to get the accurate value of A, as well as an accurate calculation of the water flow velocity V.

The following are some of the key considerations and challenges faced generally by external meters in determining accurate values for D and V. The inner pipe diameter D is shown as the distance between opposite inner pipe 200 walls. For in-line, intrusive, ultrasonic water meters, the pipe diameter D can be tightly controlled as part of the design and manufacturing processes, and thus be a known constant. However, for external ultrasonic water meters, the underlying water pipe can be one of a multitude of diameters (i.e. ⅝″, 3/4″, 1″, 1-¼″, 1-½″, etc.), and more critically, for a known external pipe diameter, the thickness of wall of the pipe can vary significantly based on pipe manufacturing tolerances and the type of the pipe. See, e.g.: Types K, L, or M for copper pipes, according to the “Copper Tube Handbook,” CDA Publication A4015-14/19 from the Copper Development Association, pg. 64-66. Furthermore, with years of usage, the water pipe at the point of measurement may have accumulated deposits or have corroded on the inside, altering the inner diameter over time and thus the effective water flow cross section area. Therefore, for the case of external ultrasonic water meters, the uncertainties around the value of D can be prohibitively large to allow for water flow rate measurements with sufficient accuracy.

The velocity V can be calculated as:

$$V = ( {C}^{2} \cdot DToF ) / ( 2 L )$$

where C is the speed of sound in water, which varies significantly with the water temperature; DToF is the difference in time of flight values between upstream and downstream directions; and L represents the exact distance the ultrasonic waves travel in the water medium.

An alternate method for calculating V, which eliminates the highly temperature dependent parameter C from the calculations, is outlined in “An Implementation of Ultrasonic Water Meter using dToF Measurement” August 2017 by Chul-Ho Lee, Hye-Kyung Jeon and Youn-Sik Hong, and in TI Application Report SNIA020 “Ultrasonic Sensing for Water Flow Meters and Heat Meters, April 2015”, the disclosure of both of which, including the disclosures related to systems and methods for measuring flow, are incorporated by reference herein in their entirety. Here the equation for V becomes:

$$V = ( L \cdot DToF ) / ( {t}_{L}^{2} )$$

where t_{L} is the average of the upstream/downstream time it takes the ultrasonic wave to travel through the water medium.

The accurate calculation of V can then be dependent on having accurate values for (i) t_{L}, (ii) DToF, and (iii) L. In addition, depending on the ultrasonic transducer setup configuration, if the ultrasonic wave's transmission path is not parallel to the direction of the water flow in the pipe, the angle of incidence of the ultrasonic wave relative to the water flow direction as represented by θ, can also be required to calculate V. For in-line water meters, the value of L is a known constant as it is fixed by design and can be controlled in the meter manufacturing process and/or accounted for in the factory calibration process. Thus V can be calculated with sufficient accuracy based on accurate measurements of DToF and t_{L}. However, for external ultrasonic water meters, the value for L is not a constant and is not readily available. L is dependent on the pipe inner diameter D, which is not known with sufficient accuracy as discussed above. In addition, L is affected by variations in the pipe wall thickness W for a given piezoelectric transducer upstream/downstream pair placement/positioning. Furthermore, even if the values of D and W were known accurately, the fact is that L is not a constant over the expected water temperature operating range, since L varies with the variation of the speed of sound in water, caused by variations in the water temperature, as the angle of incidence of the ultrasonic waves in the water, θ, also varies with the water temperature, as well as with the specific pipe's material, creating further complications, variability and uncertainties. Therefore, for external ultrasonic water meters, the uncertainties around the value of L, as well as the ultrasonic wave incidence angle θ, can be prohibitively large, preventing water flow rate measurements with sufficient accuracy.

In miscellaneous embodiments, the ultrasonic flow meters may employ active techniques to detect tampering. The active techniques can offer an improvement over the mechanical tamper proofing that is typically detected when next visually inspected. The active tamper detecting techniques can include: (1) if measured values of the time of flight of signals measuring water flow are outside of a defined reasonable range after having been in the range; (2) if the measured inner diameter of the pipe has increased or decreased significantly during operation in a short period of time; (3) if surface waves, travelling between the transducers, are no longer detected, or have a time of flight outside the expected time window, it can be determined that the ultrasonic flow meter has been detached from a pipe; (4) the ultrasonic flow meter is equipped with a securing band which can provide electrical connectivity for a resistance or voltage or magnetic test, where if after passing the resistance or voltage or magnetic test the meter fails the test, then it may have been tampered with; and (5) the ultrasonic flow meter may use WAN technology, including cellular networks for their connectivity. A sudden and then sustained loss of signal may be an indicator of tampering. The signal strength of other ultrasonic flow meters in the vicinity using the same WAN may also be compared to determine tampering. In a number of embodiments, one or more ultrasonic flow meters can be installed downstream from one or more other ultrasonic flow meters. This could be the case when the water line(s) that serve an apartment also serve one or more apartments, as in some multi-tenant buildings.

As suggested above, a two-piezoelectric configuration that is used to send and receive upstream and downstream ultrasonic waves is augmented by the addition of a third piezoelectric transducer. In several embodiments, the third piezoelectric transducer is placed in the middle of the first piezoelectric transducer and the second piezoelectric transducer, which themselves may be aligned in a “V-bounce” or “W-bounce” configuration. For any given installation of the external ultrasonic meter on a specific water pipe, and for the duration of the installation, this three-piezo configuration is able to discern with sufficient accuracy, independent of air or fluid/water temperature, and for the varying water pipe parameters outlined above, the values of: (1) A, the cross section area of the inner pipe through which water is flowing; (2) L, the length the ultrasonic waves travel in water; and (3) θ, the incidence angle of the ultrasonic wave into the water.

In multiple embodiments, the ultrasonic meter is configured to go through an auto-discovery and self-calibration process that includes a series of initial measurements and calculations to generate initial calibration factors, parameters and offsets, as well as periodic ongoing measurements and calculations, that augment the typical upstream/downstream signaling of the ultrasonic meter, and generate data to derive sufficiently accurate values for A, L and θ that are necessary to accurately determine the water flow rate Q, and account for environmental factors such as temperature and manufacturing and installation related uncertainties such as pipe material, diameter, wall thickness, deposits, and oxidization, water temperature, aging, among others. In many embodiments, an external ultrasonic meter is described that actively monitors for tampering, and can share information with networked microphones to improve classification of water usage events.

Additionally or alternatively, ultrasonic flow meters can be configured to go through an initial self-calibration process where the water main or supply valve is shut off to ensure that no water is flowing through the pipe at the location where the ultrasonic flow meter is coupled. The self-calibration process can include generating one or more calibration factors used in calculating the distance an ultrasonic acoustic wave travels in the water medium. Examples of such calibration factors can include (but are not limited to) time period offset constants. The time period offset constants can be used to compensate for mismatches in the ultrasonic pulse time-of-flight measured in upstream and downstream directions in a zero water flow condition. Such mismatches or asymmetries could be related to the installation and/or manufacture of the ultrasonic flow meters. The self-calibration process may be associated with a specific pipe temperature measured through the temperature sensor and the resulting values may be dependent on and adjusted for conditions when the temperature of the pipe or the temperature of the water flowing inside the pipe, is different from the self-calibration temperature. Such calibration process may be used to adjust for specific offsets that could provide time of flight adjustments. Other calibration processes could be used as appropriate to the requirements of specific applications in accordance with various embodiments of the invention.

In some embodiments, the temperature compensation is used to improve the accuracy of the delta time-of-flight measurement at very low and zero flow water rates through the water pipe that could lead to false indications of low level water flow where the water is still and not flowing through the pipe. In certain embodiments, the temperature compensation is conducted in electronic circuit assemblies, such as in the processor. Data inputs from the temperature sensor coupled to the water pipe are used to compensate for known time of flight variations relative to temperature, characteristic of ultrasonic waves of predetermined frequencies travelling in water.

In multiple embodiments, where multiple water pipes serve an individual apartment, multiple ultrasonic flow meters are installed per apartment, capturing apartment level water consumption in a specified period as well as an apartment's meter reading as the aggregation of the meter readings from all of the ultrasonic flow meters associated with the specific apartment. As suggested above, these meter readings may be facilitated by pipe clamp mechanisms in accordance with many embodiments of the invention.

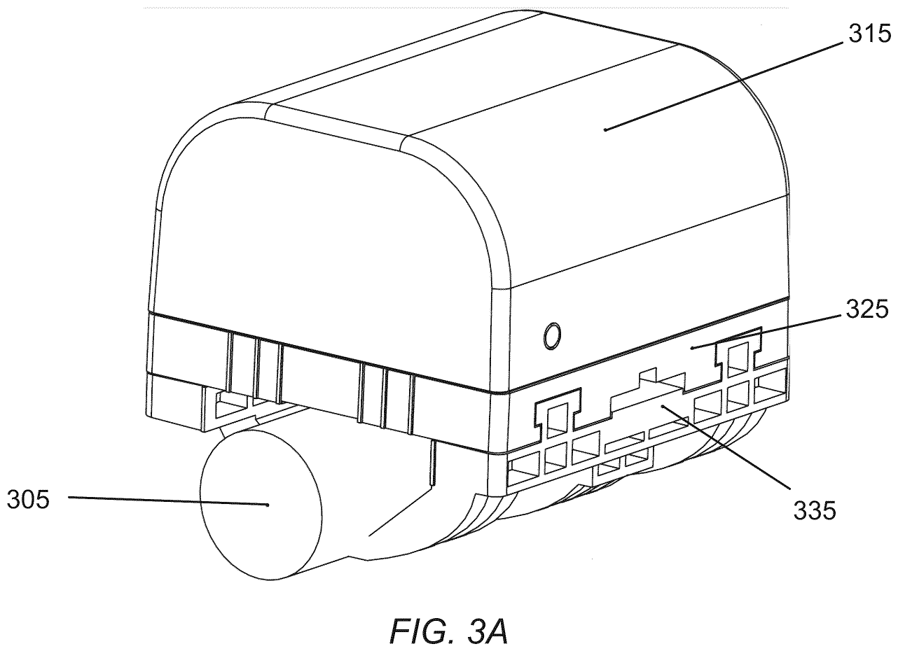

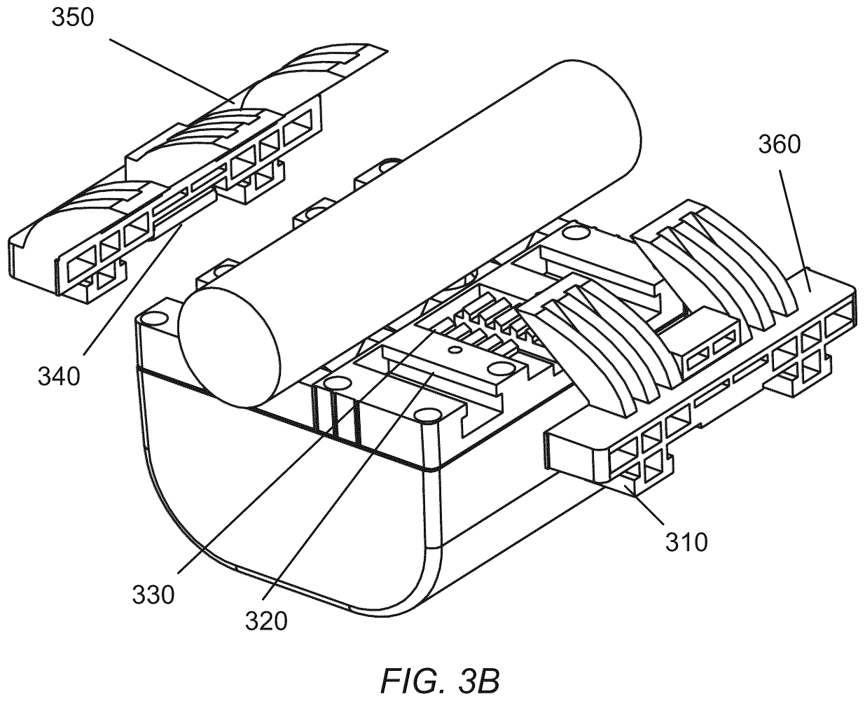

A diagram depicting a ratcheting pipe clamp mechanism for an external ultrasonic flow meter implemented in accordance with an embodiment of the invention is illustrated in FIGS. 3A-3B. The figures disclose a closed (FIG. 3A) and open (FIG. 3B) version of the configuration. The ratcheting pipe clamp mechanism can be used for clamping to a pipe 305 in order to secure an ultrasonic flow meter 315 to the pipe. In the illustrated embodiment, the ratcheting pipe clamp mechanism includes a mounting base assembly 325 and a pipe clamping mechanism 335.

Pipe clamping mechanisms configured in accordance with many embodiments of the invention may include (but are not limited to) one or more slide mounts 310, 320, clamp locking catches 330, clamp locking clips 340, and/or pipe clamps 350, 360. In accordance with various embodiments of the invention, these components may, when combined, be used to enable external flow meters to be attached to a broad range of water pipe diameters. For example, pipe clamping mechanisms can be attached to mounting base assemblies by one or more slide mounts; for example, a clamp male slide mount 310 and a clamp female slide mount 320. Pipe clamping mechanisms may, additionally and/or alternatively, be held in place by clamp locking catches 330 and/or clips 340. Pipe clamping mechanisms may be released by placing keyed tools into the side of the adjacent mounting base assemblies. As a result, pressure may be applied on water pipes in the direction of mounting base assemblies by applying inward force. This force may be applied using (but is not limited to) the force of a right pipe clamp 350 to a left pipe clamp 360 (or vice versa). In accordance with some embodiments of the invention, adequate applied pressure of water pipes to mounting base assemblies may be required for ultrasonic waves to travel into the water pipes.

While a specific ratcheting mechanism involving movement of the pipe clamps in the plane of a mounting base assembly are described above with respect to FIGS. 3A and 3B, ratcheting pipe clamp mechanisms in accordance with various embodiments of the invention can involve multiple pipe clamps rotating around one or more shafts that each employs a ratcheting mechanism. In several embodiments, each of the multiple pipe clamps is mounted to a unidirectional bearing. As can readily be appreciated, the specific manner in which the multiple pipe clamps of a ratcheting pipe clamp mechanism move relative to each other when clamping a pipe and the ratcheting mechanism used to secure the clamps in accordance with various embodiments of the invention are largely dependent upon the requirements of specific applications.

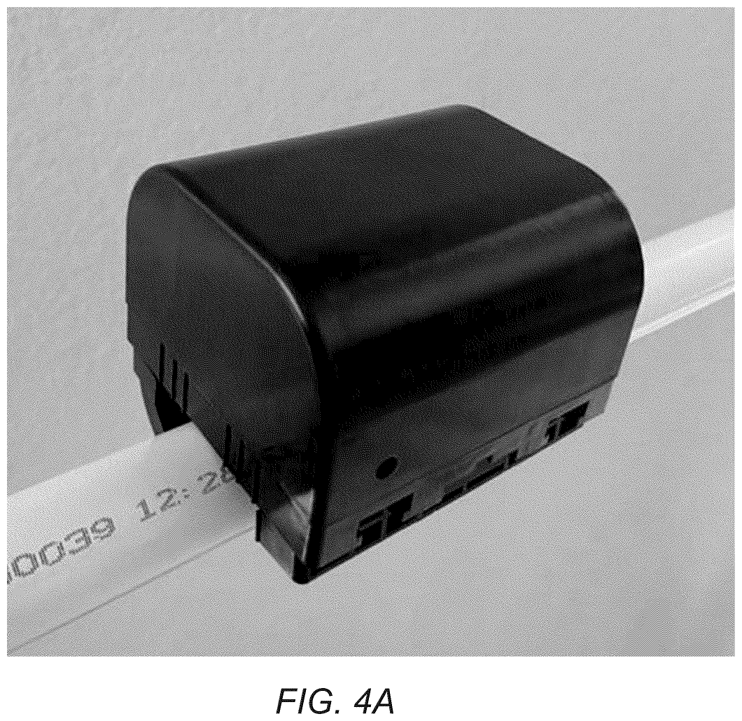

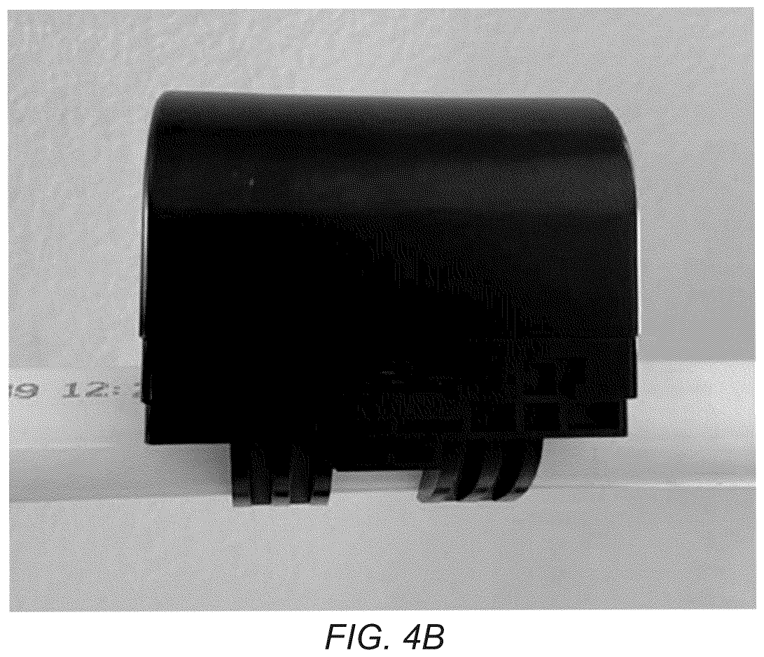

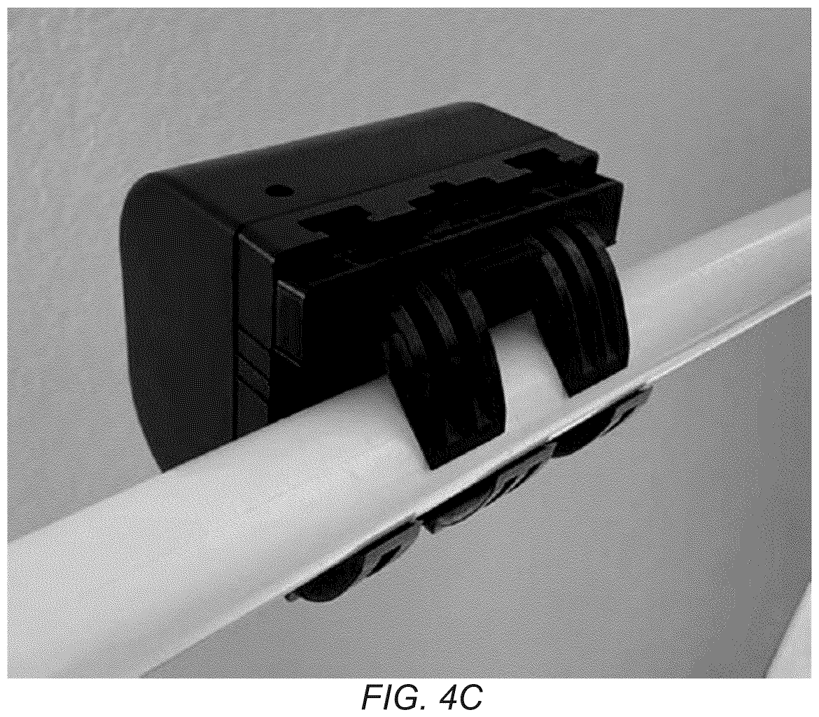

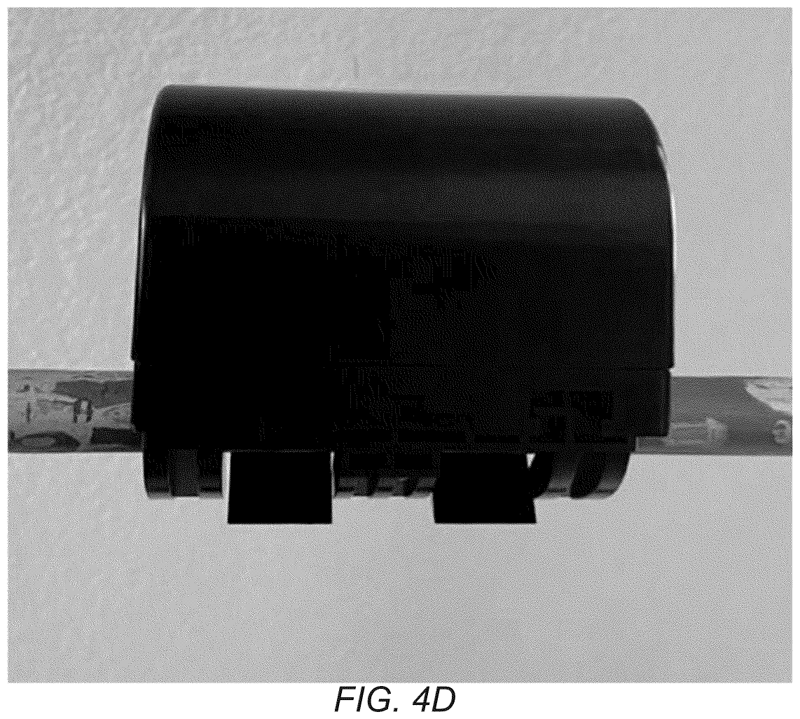

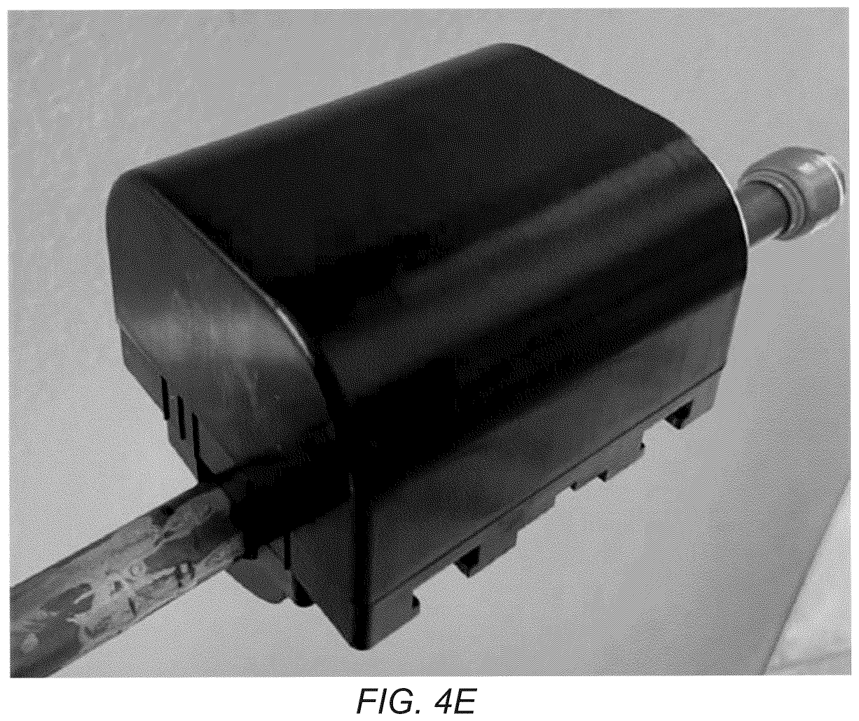

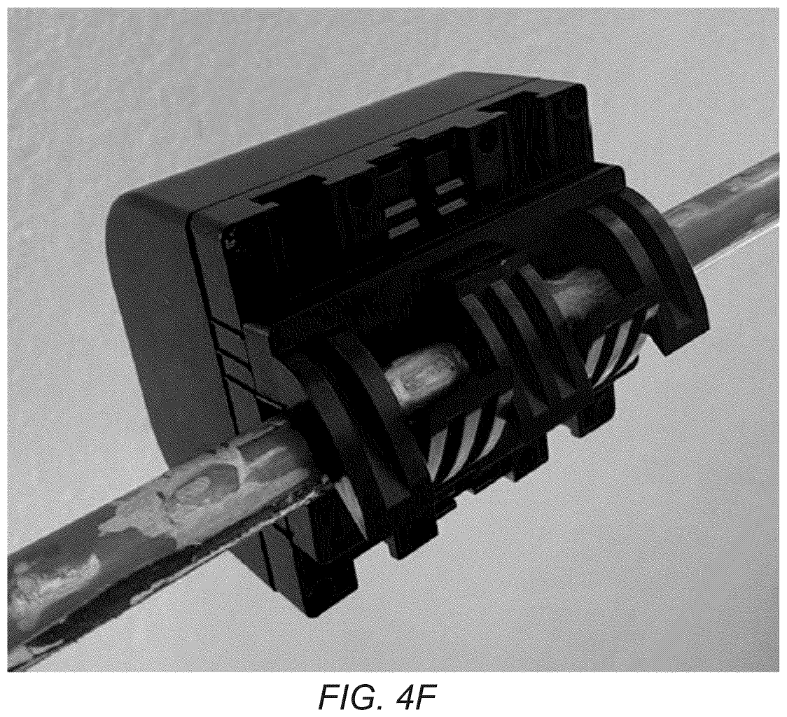

Photographs of a ratcheting pipe clamp mechanism used in attaching an ultrasonic flow meter to different pipes in accordance with some embodiments of the invention are illustrated in FIGS. 4A-4F. As mentioned above, in accordance with many embodiments of the invention, external ultrasonic flow meters can be utilized with a wide variety of water pipe materials, diameters, and/or wall thicknesses. FIGS. 4A-4E depict how the components and configurations of ratcheting pipe clamp mechanisms can convert to allow ultrasonic flow meters to attach as easily to cross-linked polyethylene (PEX) pipe with a 1-inch diameter (i.e., FIGS. 4A-4C) as to a copper pipe with a ½-inch diameter (i.e., FIGS. 4D-4F).

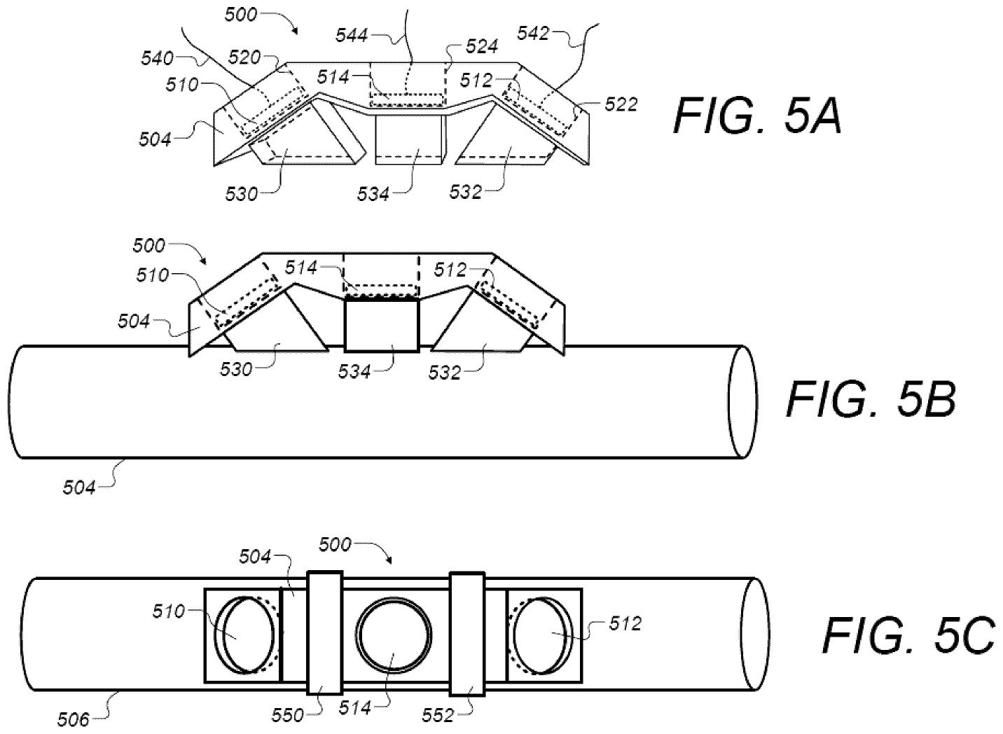

As suggested above, meters in accordance with various embodiments of the invention may be configured with sets of (e.g., piezoelectric) transceivers. A three-piezoelectric transceiver assembly for use in a ultrasonic flow meter for measuring water flow, in accordance with certain embodiments of the invention, is illustrated in FIGS. 5A-5C. FIG. 5A is a perspective view, showing the ultrasonic transceiver assembly 500 that includes three piezoelectric transceivers 510, 512 and 514. According to some embodiments, the assemblies 500 may be used in clamp-on external ultrasonic meters. The three transceivers are mounted in a solid material carrier body 504, which according to various embodiments, may be acrylic. The acrylic bodies 504 can include but are not limited to recessed pockets and/or openings, such as pockets 520, 522 and 524 that are formed in the body 504 to accept the transceivers 510, 512 and 514, respectively. In accordance with several embodiments, the carries bodies 504 may include but are not limited to solid blocks 530, 532 and 534 that are dimensioned to provide single solid material paths for the ultrasonic energy to travel to and from the transceivers 510, 512 and 514. It has been found that providing air gaps, as shown between the blocks 530, 532 and 534, can aid in reducing cross-talk interference. Also shown in FIG. 5A are electrical leads 540, 542 and 544 that are connected to transceivers 510, 512, and 514, respectively.

FIG. 5B is a side view showing the assemblies 500 mounted externally on water pipes 506. A suitable coupling material (not shown for clarity) may be provided between blocks 530, 532 and 534 and the exterior surface of the pipes 506. The coupling material can be selected to provide both adequate ultrasonic transmission properties, as well as allow the assemblies 500 to be mounted on a range of pipe sizes while optimizing the contact surface area between the pipe(s) and blocks 530, 532 and 534. In numerous embodiments clamping mechanisms may firmly hold assemblies 500 onto the exterior surface of pipes 506.

FIG. 5C is a top view showing ultrasonic transceiver assemblies 500 being clamped onto the outer surface of a water pipe 506 using clamps 550 and 552. The selection of clamping mechanism used for securely holding transceiver assemblies 500 to the outer surface of water pipes 506 in general should depend upon the anticipated conditions (e.g., possibility of direct sunlight exposure, temperature ranges) the duration of anticipated deployment as well as factors such as ease of installation. In multiple embodiments, a ratcheted fastener such as type of cable tie can be used having materials that are compatible with the anticipated pipe materials and other conditions.

It has been found that an arrangement of three ultrasound transducers, such as shown in assemblies 500 in FIGS. 5A-5C, can enable auto-discovery and self-calibration such that the external ultrasonic water meter can consistently achieve highly accurate fluid flow rate measurements of comparable accuracy to the in-line water meters. The flow meters using such arrangements described herein are therefore suitable for residential water metering and sub-metering applications. In numerous embodiments, the external ultrasonic water meters can be installed on pipes of differing diameters (whether known or unknown to the installer), having various pipe materials (i.e., copper, PVC or other), with having different pipe wall thicknesses, thickness tolerances, inner pipe deposits, and operating over expected varying ambient and water temperature ranges.

Although specific implementations of flow meters are illustrated above with respect to FIGS. 1-5C, any of a variety of elements can be utilized to assess water consumption similar to those described herein as appropriate to the requirements of specific applications. Additionally or alternatively, although specific methods of implementing water meters are discussed above with respect to ultrasonic signals, other signal modalities can be incorporated as appropriate to the requirements of specific embodiments of the invention.

### II. Connected Metering Systems

Methods in accordance with various embodiments of the invention may be performed by components of connected metering systems for monitoring, managing and optimizing water consumption in homes, multi-tenant and/or commercial buildings and/or facilities. These systems may include but are not limited to ultrasonic flow meters to measure water flowing through water pipes; user interfaces; and/or backend/remote servers. In accordance with various embodiments, ultrasonic flow meters may be configured to cooperate with network connected microphones. In numerous cases, the ultrasonic flow meters connected to (in a wired or wireless manner) network-connected microphone(s). In several embodiments, connected microphone(s) can form part of a home automation system or virtual assistant Al technology, such as Amazon's Alexa technology. The microphones can be configured and positioned to capture audio recordings, including when water consuming appliances and fixtures are operating in the home. The microphones can be connected via network to processing systems. In various cases, the processing systems may be associated classifiers for purposes including but not limited to correlating audio signatures to water usage. The classification of the audio signatures can be improved with classified water flow data that has separately correlated water flow data to the type(s) of consuming appliances and/or fixtures. Additionally or alternatively, audio classification data can also be used to improve the classification of water flow data from ultrasonic flow meters configured in accordance with some embodiments. Examples of classifications which ultrasonic flow meters and connected metering system can distinguish and assign include (but are not limited to): the operation of various household water consuming devices (e.g., toilet, dishwasher, clothes washer, sink, shower, etc.); the operation of outdoor water use (e.g., irrigation) from indoor use; conditions or failure of water consuming devices (e.g., leaking toilet); and parameters for various water consuming devices (e.g., average volume of water used per toilet flush). According to many embodiments, one or more of the example classifications can be made by systems without aid of connected microphones.

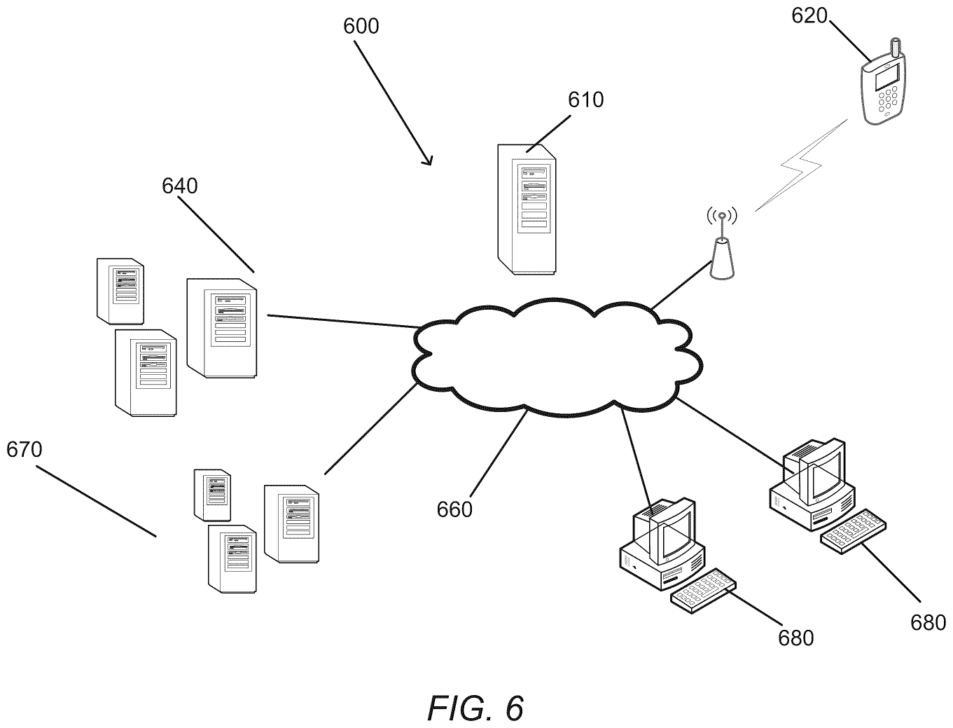

A diagram of a connected metering system for monitoring, managing and optimizing water consumption, in accordance with several embodiments is illustrated in FIG. 6. Connected metering systems 600 may include communications networks 660. A communications network 660 is a network such as the Internet that allows devices connected to the network 660 to communicate with other connected devices. Server systems 600, 640, and 670 may be connected to the network 660. Each of the server systems 600, 640, and 670 is a group of one or more servers communicatively connected to one another via internal networks that execute processes that provide cloud services to users over the network 660. One skilled in the art will recognize that connected metering systems 600 may exclude certain components and/or include other components that are omitted for brevity without departing from this invention.

For purposes of this discussion, cloud services are one or more applications that are executed by one or more server systems to provide data and/or executable applications to devices over a network. The server systems 600, 640, and 670 are shown each having three servers in the internal network. However, server systems 600, 640 and 670 implemented in accordance with various embodiments of the invention include any number of servers and any additional number of server systems may be connected to the network 660 to provide cloud services. In accordance with several embodiments of this invention, connected metering systems 600 that uses systems and methods for monitoring water consumption in accordance with an embodiment of the invention may be provided by a process being executed on a single server system and/or a group of server systems communicating over network 660.

In various embodiments, a local area network extension, such as a Bluetooth Low Energy network, may be set up and utilized for secondary applications. Examples of such secondary applications include, but are not limited to, location based services as well as messaging services. Examples of messaging services include: (i) confirmation and time stamps of delivery of packages that contain a matching BLE, or other relevant network, tags and are picked up when the package comes into proximity to the extended local network; (ii) identification of traffic of interest coming into or out of a home/apartment/site such as kids with backpacks, bicycles, vehicles, etc.; (iii) homing beacons for guiding UAVs to a specific home/site address; and (iv) electronic messages and/or commands delivered or queued to be delivered to user devices, vehicles and/or assets once such assets come into proximity of the site.

Users may use personal devices 680 and 620 that connect to the network 660 to perform processes associated with specific water consumption analyses in accordance with various embodiments of the invention. In the shown embodiment, the personal devices 680 are shown as desktop computers that are connected via a conventional “wired” connection to the network 660. However, the personal device 680 may be a desktop computer, a laptop computer, a smart television, an entertainment gaming console, or any other device that connects to the network 660 via a “wired” connection. The mobile device 620 connects to the network 660 using a wireless connection. A wireless connection is a connection that uses Radio Frequency (RF) signals, Infrared signals, or any other form of wireless signaling to connect to the network 660. In the example of this figure, the mobile device 620 is a mobile telephone. However, mobile devices 620 may include but are not limited to mobile phones, Personal Digital Assistants (PDAs), tablets, smartphones, or any other type of devices that connect to networks 660 via wireless connection without departing from this invention.

As can readily be appreciated the specific computing system used to monitor water consumption is largely dependent upon the requirements of a given application and should not be considered as limited to any specific computing system(s) implementation. One skilled in the art will recognize that system configurations may exclude certain components and/or include other components that are omitted for brevity without departing from this invention.

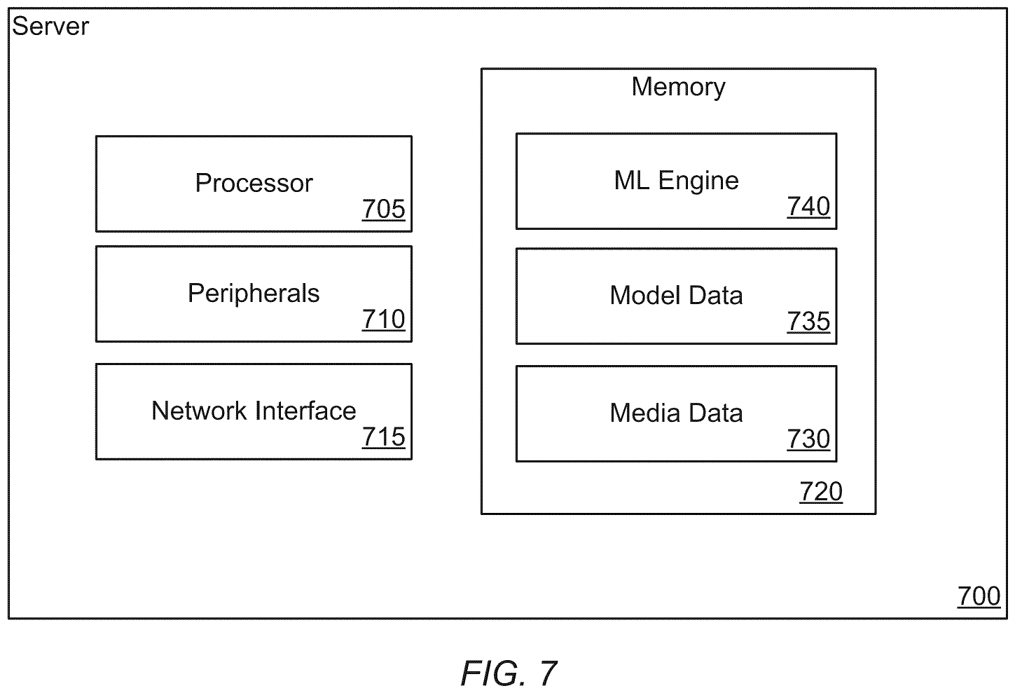

A server that performs processes for evaluating and maintaining the operation of ultrasonic flow meters in accordance with some embodiments of the invention is illustrated in FIG. 7. In multiple embodiments, servers 700 might include but are not limited to processors 705; network interfaces 715; and memory 720.

The server processor(s) 705 can include (but are not limited to) a processor, microprocessor, controller, or a combination of processors, microprocessor, and/or controllers that performs instructions stored in the memory 720 to manipulate data stored in the memory. Processor instructions can configure the processor 705 to perform processes in accordance with certain embodiments of the invention. In various embodiments, processor instructions can be stored on a non-transitory machine readable medium.

Backend servers 700 may be located in areas including but not limited to the cloud, datacenters, and/or on-premises systems. Servers 700 can provide various micro-services, including but not limited to providing a database containing the raw and processed data for individual locations; and/or analyzing water consumption details (i.e., that is received/collected from ultrasonic flow meters configured in accordance with various embodiments of the invention). The processed data in a given case may include a site's (e.g., a home's) actual water consumption per event (e.g., instance of water use) matched and/or mapped onto one or more event types. In accordance with various embodiments of the invention, event types may belong to sets of predefined and/or user-identified water consumption categories (e.g., identifying the water as being consumed by landscaping, showers, laundry, dishwasher, pool, toilet, tap, etc.). The processed data can, additionally or alternatively, include but is not limited to:
(1) the diameter of the water pipe the ultrasonic flow meter is installed upon;
(2) the meter readings that reflect the cumulative water use as typical with traditional water meters;
(3) the relationship between multiple ultrasonic flow meters that are installed on the same apartment and the aggregation of water usage data from that apartment;
(4) the relationship between multiple ultrasonic flow meters that are installed on different apartments that have cascaded water lines and the determination of the differential water usage to reflect the correct water usage for each apartment; and
(5) status information as to the health and performance of the ultrasonic flow meter, such as its self-calibration values, remaining battery life, wireless signal strength, health of the ultrasonic flow meter and detected tampering.

Peripherals 710 can include any of a variety of components for capturing data, such as (but not limited to) ultrasonic flow meters, displays, and/or other sensors. In a variety of embodiments, peripherals 710 can be used to gather inputs and/or provide outputs. Servers 700 can utilize network interface 715 to transmit and receive data over a network based upon the instructions performed by processor 705. Peripherals 710 and/or network interfaces 715 in accordance with many embodiments of the invention can be used to gather inputs that can be used to evaluate water consumption rates.

Memory 720 may, additionally or alternatively, include model data 730, media data 735, and/or Machine Learning (ML) engines 740.

Media data 735 in accordance with a variety of embodiments of the invention can include various types of media data 735 that can be used in evaluation processes. In certain embodiments, media data 735 can include (but is not limited to) meter identification and calibration data, historical sensor data, and/or account and subscription data.

In several embodiments, model data 730 can store various parameters, algorithms, and/or weights for various models that can be used for various processes as described in this specification. Model data 730 in accordance with many embodiments of the invention can be updated through training on media data 735. In multiple embodiments, model data may be used in training ML engines 740.

Servers 700 can, in numerous embodiments, be configured to incorporate ML engines 740 that may include, but are not limited to:
(1) Supervised ML algorithms used to classify and map actual water consumption data, including but not limited to the water flow rates and/or volumes relative to time (e.g., gallons per second, per minute or hour for instance) into the above water consumption categories; and
(2) Machine Learning algorithm(s) that analyze historic water consumption (e.g., on an ongoing basis) to learn the regular/common patterns of consumption and/or ingest new data coming in (e.g., from the ultrasonic flow meter) to identify aberrant/unusual water flow patterns.

In accordance with numerous embodiments of the invention, unusual water flow patterns could be indicative of anomalies including but not limited to water waste, such as steady indoor/outdoor water leaks, broken sprinklers, leaks with a periodicity such as those experienced from worn out toilet flaps. In multiple embodiments of the invention, Machine Learning algorithms may be used to match water consumption patterns of given areas with the most effective water optimization solutions from a predefined set of water conservation solutions. These solutions may include but are not limited to smart irrigation systems, low water landscaping solutions, pool covers, low flow showers, more water efficient toilets and appliances, water capture systems, and other more water efficient options.

Servers 700 can, in many cases, be configured to perform a variety of processes including but not limited to sending alerts and messages to consumers; transporting commands and data to and from ultrasonic flow meters; managing system accounts; coordinating account setup; providing current installation instructions; activating ultrasonic flow meters; pairing meters with particular sites; etc. Such services could require data including, but not limited to the physical address of the site; contact info (email address, cell phone/text number, consumer preferences); ultrasonic flow meter serial number; SIM card ICCID; IMEI and/or ESN number. Servers 700 can also be configured to provide: data de-compression applications to process the compressed meter data; and/or meter and network health monitoring applications that monitor and report on the health and projected longevity of ultrasonic flow meters and the quality of the network connectivity. Servers 700 can be configured to provide applications to capture specific operational insights for managers, such as estimation of the number of individuals living in an apartment, based on the number of showers and toilet flushes or other water usage patterns in a specified period, unexpected water use in apartments that are tagged to be unoccupied, and generating alerts for the exception cases.

Although specific methods and systems for ultrasound water metering are discussed above, many different ultrasonic flow meter configurations can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, and/or the discussion of specific embodiments, but based upon the entirety of the disclosure provided herein including the various documents incorporated by reference.

What is claimed is:

1. An ultrasonic flow meter, the ultrasonic flow meter comprising:
a clamp-on carrier assembly, wherein:
the clamp-on carrier assembly comprises a ratcheting clamp configured to externally mount the clamp-on carrier assembly to an assessed pipe; and
a medium has a direction of flow through the assessed pipe;
at least three ultrasonic transducers, mounted to the clamp-on carrier assembly, wherein each of the at least three ultrasonic transducers is configured to transmit and/or sense ultrasonic acoustic waves propagating through the medium in the assessed pipe; and
a processor, mounted to the clamp-on carrier assembly and configured to calculate a flow rate for the medium based on time of flight measurements determined between two or more of the at least three ultrasonic transducers.

2. The ultrasonic flow meter of claim 1, wherein:
the medium is water; and
the at least three ultrasonic transducers comprise piezoelectric transceivers.

3. The ultrasonic flow meter of claim 1, wherein a first ultrasonic transducer and a second ultrasonic transducer of the at least three ultrasonic transducers are configured to transmit and/or sense a first subset of the ultrasonic acoustic waves to propagate at oblique angles relative to the direction of flow of the medium.

4. The ultrasonic flow meter of claim 3, wherein a third ultrasonic transducer of the at least three ultrasonic transducers is configured to transmit and/or sense a second subset of the ultrasonic acoustic waves to propagate at approximate right angles relative to the direction of flow of the medium.

5. The ultrasonic flow meter of claim 4, wherein at least some of the time of flight measurements determined by the third ultrasonic transducer are determined when the medium is present and not flowing through the assessed pipe.

6. The ultrasonic flow meter of claim 5, wherein:
calculating the flow rate is based in part on a calculation of at least one diameter of the assessed pipe; and
the calculation of the at least one diameter is derived from the at least some of the time of flight measurements determined by the third ultrasonic transducer.

7. The ultrasonic flow meter of claim 6, wherein:
calculating the flow rate is further based on a calculation of a cross-sectional area of the assessed pipe; and
the calculation of the cross-sectional area is determined from the at least one diameter.

8. The ultrasonic flow meter of claim 4, wherein a fourth ultrasonic transducer of the at least three ultrasonic transducers is configured to transmit and/or sense a third subset of the ultrasonic acoustic waves to propagate at oblique angles relative to the direction of flow of the medium.

9. The ultrasonic flow meter of claim 8, wherein:
a first subset of the time of flight measurements are determined between the first ultrasonic transducer and the second ultrasonic transducer; and
a second subset of the time of flight measurements are determined between the first ultrasonic transducer and the fourth ultrasonic transducer.

10. The ultrasonic flow meter of claim 9, wherein:
a more reliable subset of the first subset and the second subset of the time of flight measurements is determined by the processor; and
the more reliable subset is used to determine the flow rate.

11. The ultrasonic flow meter of claim 1, wherein the ratcheting clamp comprises:
a mounting base assembly; and
a pipe clamping mechanism comprising a right clamp and a left clamp.

12. The ultrasonic flow meter of claim 11, wherein the pipe clamping mechanism is attached to the mounting base assembly using a male slide mount and a female slide mount.

13. The ultrasonic flow meter of claim 11, wherein the pipe clamping mechanism is released when a keyed tool is placed into one side of the mounting base assembly.

14. The ultrasonic flow meter of claim 11, wherein:
the ratcheting clamp is reconfigured, using the pipe clamping mechanism, to attach to a second pipe; and
the second pipe has a different diameter than the assessed pipe.

15. The ultrasonic flow meter of claim 14, wherein the assessed pipe and the second pipe each have external diameters within a range of ½″ to 2″.

16. The ultrasonic flow meter of claim 11, wherein the pipe clamping mechanism is held in place, when the ratcheting clamp is closed, using a clamp locking clip and a clamp locking catch.

17. The ultrasonic flow meter of claim 1, wherein:
the clamp-on carrier assembly further comprises at least one additional ratcheting clamp; and
each of the at least one additional ratcheting clamp is mounted to a singular a unidirectional bearing.

18. The ultrasonic flow meter of claim 1, wherein the processor is further configured to detect a presence or absence of ultrasonic acoustic waves travelling along an exterior surface of the assessed pipe.

19. The ultrasonic flow meter of claim 18, wherein the processor is further configured to determine an instance of tampering from detecting the absence of ultrasonic acoustic waves travelling along the exterior surface of the assessed pipe.

20. The ultrasonic flow meter of claim 19, wherein:
the ultrasonic flow meter further comprises a network interface; and
the processor is further configured to transmit an alert to an external device, in response to the instance of tampering, using the network interface.
